(19) United States
(12) Patent Application Publication
(10) Pub. No.: US 2011/0162751 A1
(43) Pub. Date: Jul. 7, 2011

(54) Protective Coatings for Petrochemical and Chemical Industry Equipment and Devices

(75) Inventors: Brian Joseph Fitzgerald, Kingwood, TX (US); Hyun-Woo Jin, Easton, PA (US); Raghavan Ayer, Bridgewater, NJ (US); Yu Feng Wang, Houston, TX (US)

(73) Assignee: ExxonMobil Research and Engineering Company, Annandale, NJ (US)

(21) Appl. No.: 12/958,203

(22) Filed: Dec. 1, 2010

Related U.S. Application Data
(60) Provisional application No. 61/284,685, filed on Dec. 23, 2009.

(51) Int. Cl. F16L 9/14; B05D 1/36; B05D 3/02; B05D 5/00; B05D 7/00; C25D 3/56; C25D 7/04; C25D 9/00; B82Y 30/00

(52) U.S. Cl. 138/145; 427/256; 205/238; 205/318; 205/316; 977/734

(57) ABSTRACT

Provided are coated petrochemical and chemical industry devices and methods of making and using such coated devices. In one form, the coated petrochemical and chemical industry device includes a petrochemical and chemical industry device including one or more bodies, and a coating on at least a portion of the one or more bodies, wherein the coating is chosen from an amorphous alloy, a heat-treated electroless or electro plated based nickel-phosphorous composite with a phosphorous content greater than 12 wt %, graphite, MoS₂, WS₂, a fullerene based composite, a boride based cermet, a quasicrystalline material, a diamond based material, diamond-like-carbon (DLC), boron nitride, and combinations thereof. The coated petrochemical and chemical industry devices may provide for reduced friction, wear, corrosion and other properties required for superior performance.

### CROSS-REFERENCE TO RELATED APPLICATIONS

This application claims priority to U.S. Provisional Application Ser. No. 61/284,685 filed Dec. 23, 2009, herein incorporated by reference in its entirety.

### FIELD

The present disclosure relates to the field of petrochemical and chemicals industry operations. It more particularly relates to the use of coatings to reduce friction, wear, corrosion, erosion, and deposits on petrochemical and chemical industry devices. Such coated petrochemical and chemical industry devices include extruders, dies, gears, valves and other equipments and/or components that suffer mechanical or chemical form of degradation or have high energy costs from poor efficiency resulting from, for example, high friction.

### BACKGROUND

Components for equipment in petrochemical and chemical production suffer from degradation ranging from mechanical and chemical effects. For instance, components undergo wear due to repeated rubbing of surfaces resulting in failure requiring repair or replacement. Under certain circumstances, the debris produced by wear may also contaminate the product making it unacceptable. In addition to wear, excessive friction between surfaces could also enhance the energy required for the operation. Higher energy costs may also be realized while pumping fluids in the operation due to excessive friction or resistance between the fluid and the surface of the component that transmits it. Another example of degradation of components may relate to corrosion where the components need to be replaced periodically. Corrosion may also lead to fouling in the inner diameter of heat exchanger tubulars resulting in degradation of the heat transfer efficiency. These are all potential impediments to successful petrochemical operations that may be costly, or even prohibitive, to correct, repair, or mitigate.

Non-limiting exemplary applications of such coatings include extruders, barrels, gear boxes, bearings, compressors, pumps, pipes, tubing, molding dies, valves, and reactor vessels.

### Extrusion Barrels:

Extrusion barrels are critical components in the production of butyl, polyethylene and polypropylene production in chemical plants. The extruder to barrels are made of steel and lined with a nickel based alloy using either welding or a solid state process. The diameter of the barrels may range from 1″ to up to 10″ with larger diameter barrels being used increasingly to improve productivity. The polymer product is pushed through the extruder by one or more rotating screws. During operation, the screws make intermittent contact with the barrel with a thin layer of the product between them. The intermittent contact may result in a cyclic stress state on the barrel causing failure by fatigue. An introduction of a hard and low friction coating may enhance the fatigue resistance of the barrel as well as reduce the energy required for the extrusion. It is also likely that coating of the barrel and the screw would produce an even higher level of fatigue resistance and higher reduction in the energy consumed.

### Extrusion Dies:

Extrusion dies also undergo abrasion and wear. Coatings that have less of a propensity to wear and low friction coefficient may significantly enhance the life of the dies, in addition to improving the energy efficiency.

### Gears and Rotating Components:

Gears in various machinery in petrochemical and chemical plants are subjected to various forms of wear such as pitting and scuffing. Coatings with low friction and high hardness may enhance the performance, both integrity and energy.

### Other Components:

There are numerous other equipment and components in a refinery or chemical plant that suffer from fatigue, wear, erosion and corrosion.

Hence there is a need for improved coatings for machinery, equipment devices and components for the petrochemical and chemical industry, which will reduce friction, wear, corrosion, erosion, and deposits.

### SUMMARY

According to the present disclosure, an advantageous coated petrochemical and chemical industry device comprises: one or more tubular bodies, and a coating on at least a portion of the one or more tubular bodies, wherein the coating is chosen from an amorphous alloy, a heat-treated electroless or electro plated based nickel-phosphorous composite with a phosphorous content greater than 12 wt %, graphite, MoS₂, WS₂, a fullerene based composite, a boride based cermet, a quasicrystalline material, a diamond based material, diamond-like-carbon (DLC), boron nitride, and combinations thereof.

A further aspect of the present disclosure relates to an advantageous coated petrochemical and chemical industry device comprising: a petrochemical and chemical industry device chosen from extruder barrels, gears, extruder dies and combinations thereof, and including a coating on at least a portion of the device, wherein the coating is chosen from an amorphous alloy, a heat-treated electroless or electro plated based nickel-phosphorous based composite with a phosphorous content greater than 12 wt %, graphite, MoS₂, WS₂, a fullerene based composite, a boride based cermet, a quasicrystalline material, a diamond based material, diamond-like-carbon (DLC), boron nitride, and combinations thereof.

A still further aspect of the present disclosure relates to an advantageous method for coating a petrochemical and chemical industry device comprising: providing a petrochemical and chemical industry device including one or more tubular bodies, and a coating on at least a portion of the one or more tubular bodies, wherein the coating is chosen from an amorphous alloy, a heat-treated electroless or electro plated based nickel-phosphorous composite with a phosphorous content greater than 12 wt %, graphite, MoS₂, WS₂, a fullerene based composite, a boride based cermet, a quasicrystalline material, a diamond based material, diamond-like-carbon (DLC), boron nitride, and combinations thereof, and utilizing the coated petrochemical and chemical industry device in various chemical operations.

These and other features and attributes of the disclosed coated petrochemical and chemical industry devices, methods for coating such devices for reducing friction, wear, corrosion, erosion, and deposits in such application areas, and their advantageous applications and/or uses will be apparent from the detailed description which follows, particularly when read in conjunction with the figures appended hereto.

### BRIEF DESCRIPTION OF THE DRAWINGS

To assist those of ordinary skill in the relevant art in making and using the subject matter hereof, reference is made to the appended drawings, wherein:

FIG. 1 is a side view of a tubular petrochemical device with one embodiment of the coatings disclosed herein on the inner surface thereon.

FIG. 2 depicts the relationship between coating COF and coating hardness for some of the coatings disclosed herein versus steel base case.

FIG. 3 depicts a representative stress-strain curve showing the high elastic limit of amorphous alloys compared to that of crystalline metals/alloys.

FIG. 4 depicts a ternary phase diagram of amorphous carbons.

FIG. 5 depicts a schematic illustration of the hydrogen dangling bond theory.

FIG. 6 depicts the velocity-weakening performance of DLC coating in comparison to an uncoated bare steel substrate.

FIG. 7 depicts SEM cross-sections of single layer and multi-layered DLC coatings disclosed herein.

FIG. 8 depicts water contact angle for DLC coatings versus uncoated 4142 steel.

### DETAILED DESCRIPTION

All numerical values within the detailed description and the claims herein are modified by “about” or “approximately” the indicated value, and take into account experimental error and variations that would be expected by a person having ordinary skill in the art.

U.S. Provisional Patent Application No. 61/189,530 filed on Aug. 20, 2008, herein incorporated by reference in its entirety, discloses the use of ultra-low friction coatings on drill stem assemblies used in gas and oil drilling applications. Other oil and gas well production devices may benefit from the use of the coatings disclosed herein. A drill stem assembly is one example of a production device that may benefit from the use of coatings. The geometry of an operating drill stem assembly is one example of a class of applications comprising a cylindrical body. In the case of the drill stem, the actual drill stem assembly is an inner cylinder that is in sliding contact with the casing or open hole, an outer cylinder. These devices may have varying radii and alternatively may be described as comprising multiple contiguous cylinders of varying radii. As described below, there are several other instances of cylindrical bodies in oil and gas well production operations, either in sliding contact due to relative motion or stationary subject to contact by fluid flowstreams. The inventive coatings may be used advantageously for each of these applications by considering the relevant problem to be addressed, by evaluating the contact or flow problem to be solved to mitigate friction, wear, corrosion, erosion, or deposits, and by judicious consideration of how to apply such coatings to the specific devices for maximum utility and benefit.

U.S. Provisional Patent Application No. 61/207,814 filed on Feb. 17, 2009, herein incorporated by reference in its entirety, discloses the use of ultra-low friction coatings on oil and gas well production devices and methods of making and using such coated devices. In one form, the coated oil and gas well production device includes an oil and gas well production device including one or more bodies, and a coating on at least a portion of the one or more bodies, wherein the coating is chosen from an amorphous alloy, a heat-treated electroless or electro plated based nickel-phosphorous composite with a phosphorous content greater than 12 wt %, graphite, MoS₂, WS₂, a fullerene based composite, a boride based cermet, a quasicrystalline material, a diamond based material, diamond-like-carbon (DLC), boron nitride, and combinations thereof. The coated oil and gas well production devices may provide for reduced friction, wear, corrosion, erosion, and deposits for well construction, completion and production of oil and gas.

The instant disclosure relates to coatings to protect petrochemical apparatus from service environments and methods of using such apparatus with coatings thereon in petrochemical production. More specifically, this disclosure pertains to protective coatings on selected components of petrochemical apparatus with certain materials including the compositions described herein. The coatings would be tailored to deliver specific properties to the component surface, with some examples being, hydrophoebicity, low friction, wear resistance, erosion resistance and corrosion resistance.

The method of coating such devices disclosed herein includes applying a suitable coating to a portion of at least one device that will be subject to friction, wear, corrosion, erosion, and/or deposits. A coating is applied to at least a portion of the surface of at least one device that is exposed to contact with another solid or with a fluid flowstream, wherein the coefficient of friction of the coating is less than or equal to 0.15; the hardness of the coating is greater than 400 VHN; the wear resistance of the coated device is at least 3 times that of the uncoated device; and/or the surface energy of the coating is less than 1 J/m². In choosing the appropriate coating from the coatings disclosed herein, a number of factors are considered including, but not limited to, the specific application method, and the selection of the surfaces to be coated to maximize the technical and economic advantages of this technology for each specific application. However, there are common elements among these diverse application areas that provide a unifying theme to the coating methods and applications.

There are many more examples of petrochemical and chemical industry devices that provide opportunities for beneficial use of coatings on portions of the surfaces of various bodies, as described in the background, including: stationary bodies coated for corrosion and erosion resistance and resistance to deposits on external or internal surfaces, or both; stationary devices coated for friction reduction and resistance to erosion and wear; friction reduction, galling resistance, and metal-to-metal seal performance; and bearings, bushings, and other geometries coated for friction and wear reduction and for erosion, corrosion, and wear resistance.

In each case, there may be primary and secondary motivations for the use of coatings to mitigate friction, wear, corrosion, erosion, and deposits. Different portions of the same body may have different coatings applied to address different coatings design aspects, including the issue to be addressed, the technology available for application of the coatings, and the economics associated with each type of coating. There will likely be many tradeoffs and compromises that govern the ultimate selection for coating applications.

### Overview of Use of Coatings and Associated Benefits:

The current disclosure relates to the use of functional coatings to improve the performance and integrity of all relevant petrochemical equipments where modification of the surface properties would enhance one or more performance characteristics of the equipment. Examples of properties the coatings would enhance include, but not limited to, corrosion, wear, erosion, and friction. The equipment could be made up of a range of materials such as metallic, ceramic, polymeric and mixtures thereof, and the coating would be applied to selected regions or the entire component.

The performance enhancement resulting from the coatings disclosed herein for petrochemical and chemical applications could be extended equipment life, reduced maintenance and replacement costs, lower energy consumption and others. The equipment that will be impacted by this technology would be either directly related to the production of petrochemical and chemicals but also peripheral components that aid in the production of the above.

Components of equipments in petrochemical and chemical production suffer from degradation ranging from mechanical and chemical effects. For instance, components undergo wear due to repeated rubbing of surfaces resulting in failure requiring repair or replacement. Under certain circumstances, the debris produced by wear could also contaminate the product making it unacceptable. In addition to wear excessive friction between surfaces could also enhance the energy required for the operation. Higher energy costs may also be realized while pumping fluids in the operation due to excessive friction or resistance between the fluid and the surface of the component that transmits it. Other example of degradation of components could relate to corrosion where the components need to be replaced periodically. Corrosion could also lead to fouling in the inner diameter of heat exchanger tubulars degradation the heat transfer efficiency. These are all potential impediments to successful petrochemical operations that may be costly, or even prohibitive, to correct, repair, or mitigate. All degradations listed above and others may be mitigated by selective use of coatings as described below.

Another aspect of the current disclosure relates to the use of functional coatings to reduce vibration caused by friction in petrochemical equipment. Vibration can cause equipment damage, energy loss, and noise. The primary cause of friction-induced vibration has been identified as velocity weakening, which is the decrease of friction force with increasing sliding speeds. The static contact friction of various petrochemical components and also the dynamic response of this contact friction as a function of sliding speed may be important for the onset of vibration.

Non-limiting exemplary applications of such coatings include extruders, barrels, gear boxes, bearings, compressors, pumps, pipes, tubing, molding dies, valves, and reactor vessels.

### Coated Tubular Bodies in Sliding Contact Due to Relative Motion:

In an application that is ubiquitous throughout production operations, two tubular bodies are in contact, and friction and wear occur as one body moves relative to the other. The bodies may be comprised of multiple tubular sections that are placed contiguously with varying radii, and the cylinders may be placed coaxially or non-coaxially. Coating small areas of at least one of the tubular bodies, perhaps a removable part that may subsequently be serviced or replaced, may be beneficial. For example, coating portions of the tool joints of drill pipe may be an effective means to utilize coatings to reduce the contact friction between drill stem and casing or open-hole. In another application, for instance plunger lift devices, it may be advantageous to coat the entire surface area of the smaller object, the plunger lift device. In addition to friction reduction, wear performance may also be enhanced via the coatings disclosed herein. The coated tubular bodies in sliding contact relative motion also may exhibit improved hardness, which provides improved wear resistance.

### Plates, Disks, Gears and Complex Geometries:

There are many coatings applications that may be considered for non-tubular devices such as plates and disks or for more complex geometries. The benefits of coatings may be derived from a reduction in sliding contact friction and wear resulting from relative motion with respect to other devices, or perhaps a reduction in corrosion, erosion, and deposits from the interaction with fluid streams, or in many cases by a combination of both.

### Exemplary Embodiments of the Current Disclosure

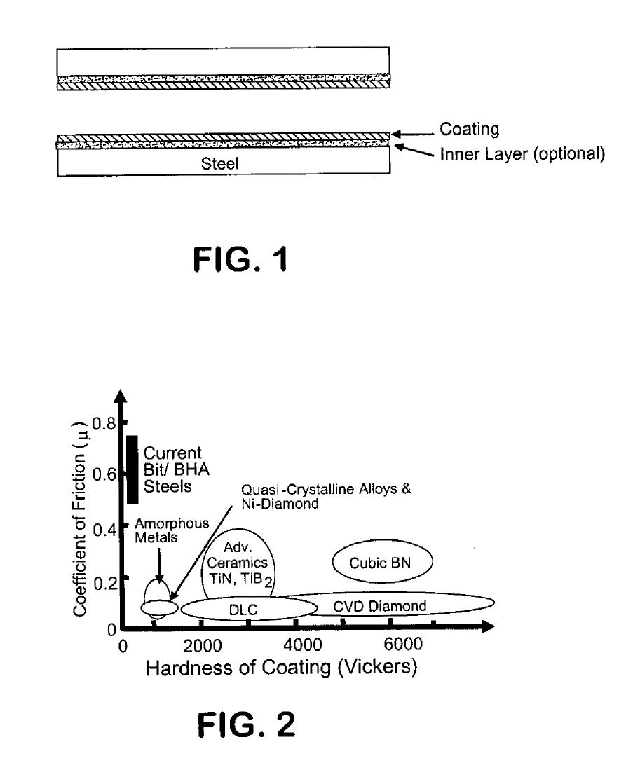

FIG. 1 is a side view of a tubular petrochemical device with one embodiment of the coatings disclosed herein on the inner flow surface thereon. In particular, the inventive coatings disclosed herein may be on the inner flow surface of the tubular device with an optional inner layer (also referred to as a buttering layer or buffering layer) between the device and the coating.

In one exemplary embodiment of the current invention, a coated petrochemical or chemical device comprises a device including one or more tubular bodies, and a coating on at least a portion of the one or more tubular bodies, wherein the coating is chosen from an amorphous alloy, a heat-treated electroless or electro plated nickel-phosphorous based composite with a phosphorous content greater than 12 wt %, graphite, MoS₂, WS₂, a fullerene based composite, a boride based cermet, a quasicrystalline material, a diamond based material, diamond-like-carbon (DLC), boron nitride, and combinations thereof.

In another exemplary embodiment of the current invention, the coated a petrochemical and chemical industry device is chosen from extruder barrels, gears, extruder dies and combinations thereof, and a coating on at least a portion of the device, wherein the coating is chosen from an amorphous alloy, a heat-treated electroless or electro plated nickel-phosphorous based composite with a phosphorous content greater than 12 wt %, graphite, MoS₂, WS₂, a fullerene based composite, a boride based cermet, a quasicrystalline material, a diamond based material, diamond-like-carbon (DLC), boron nitride, and combinations thereof.

The coefficient of friction of the coating may be less than or equal to 0.15, or 0.13, or 0.11, or 0.09 or 0.07 or 0.05. The friction force may be calculated as follows: Friction Force=Normal Force×Coefficient of Friction. In another form, the coated oil and gas well production device may have a dynamic friction coefficient of the coating that is not lower than 50%, or 60%, or 70%, or 80% or 90% of the static friction coefficient of the coating. In yet another form, the coated oil and gas well production device may have a dynamic friction coefficient of the coating that is greater than or equal to the static friction coefficient of the coating.

The coated petrochemical or chemical device may be fabricated from iron based steels, Al-base alloys, Ni-base alloys, Ti-base alloys, ceramics polymers and combinations thereof. 4142 type steel is one non-limiting exemplary iron based steel used for petrochemical devices. The surface of the iron based steel substrate may be optionally subjected to an advanced surface treatment prior to coating application. The advanced surface treatment may provide one or more of the following benefits: extended durability, enhanced wear, reduced friction coefficient, enhanced fatigue and extended corrosion performance of the coating layer(s). Non-limited exemplary advanced surface treatments include ion implantation, nitriding, carburizing, shot peening, laser and electron beam glazing, laser shock peening, and combinations thereof. Such surface treatments may harden the substrate surface by introducing additional species and/or introduce deep compressive residual stress resulting in inhibition of the crack growth induced by fatigue, impact and wear damage.

The coating disclosed herein may be chosen from an amorphous alloy, electroless and/or electro plating nickel-phosphorous based composite, graphite, MoS₂, WS₂, a fullerene based composite, a boride based cermet, a quasicrystalline material, a diamond based material, diamond-like-carbon (DLC), boron nitride, and combinations thereof. The diamond based material may be chemical vapor deposited (CVD) diamond or polycrystalline diamond compact (PDC). In one advantageous embodiment, the petrochemical device is coated with a diamond-like-carbon (DLC) coating, and more particularly the DLC coating may be chosen from tetrahedral amorphous carbon (ta-C), tetrahedral amorphous hydrogenated carbon (ta-C:H), diamond-like hydrogenated carbon (DLCH), polymer-like hydrogenated carbon (PLCH), graphite-like hydrogenated carbon (GLCH), silicon containing diamond-like-carbon (Si-DLC), metal containing diamond-like-carbon (Me-DLC), oxygen containing diamond-like-carbon (O-DLC), nitrogen containing diamond-like-carbon (N-DLC), boron containing diamond-like-carbon (B-DLC), fluorinated diamond-like-carbon (F-DLC) and combinations thereof.

Significantly decreasing the coefficient of friction (COF) of the petrochemical device will result in a significant decrease in the friction force. Lowering the COF on petrochemical device surfaces is accomplished by coating these surfaces with coatings disclosed herein. These coatings applied to petrochemical devices are able to withstand the aggressive environments of chemical environments including resistance to corrosion, impact loading and exposure to high temperatures.

In addition to low COF, the coatings of the present invention are also of sufficiently high hardness to provide durability against wear chemical operations. More particularly, the Vickers hardness or the equivalent Vickers hardness of the coatings on the petrochemical device disclosed herein may be greater than or equal to 400, 500, 600, 700, 800, 900, 1000, 1500, 2000, 2500, 3000, 3500, 4000, 4500, 5000, 5500, or 6000. FIG. 2 depicts the relationship between coating COF and coating hardness for some of the coatings disclosed herein relative to the prior art. The combination of low COF and high hardness for the coatings disclosed herein when used as a surface coating on petrochemical devices provides for hard, low COF durable materials.

The coated petrochemical devices with the coatings disclosed herein also provide a surface energy less than 1, 0.9, 0.8, 0.7, 0.6, 0.5, 0.4, 0.3, 0.2, or 0.1 J/m². Contact angle may also be used to quantify the surface energy of the coatings on the coated petrochemical devices disclosed herein. The water contact angle of the coatings disclosed herein is greater than 50, 60, 70, 80, or 90 degrees.

Further details regarding the coatings disclosed herein for use in coated petrochemical devices are as follows:

### Amorphous Alloys:

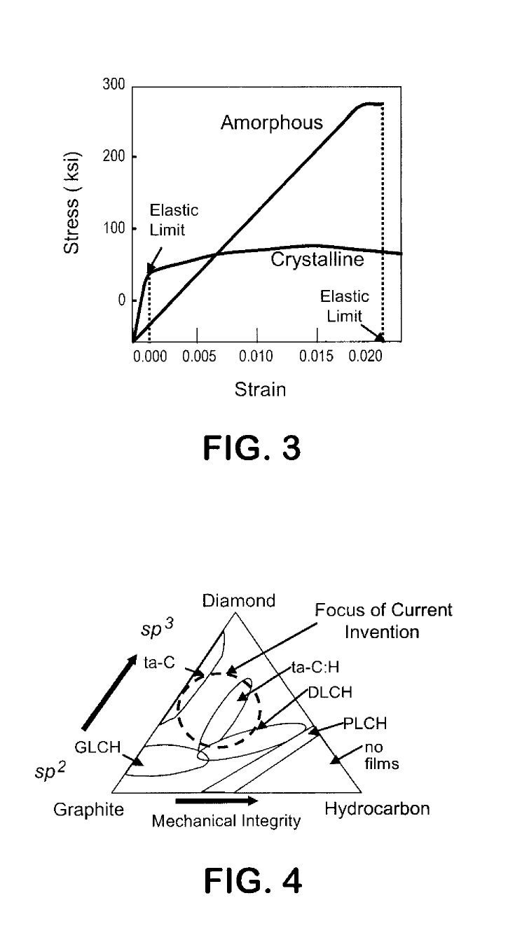

Amorphous alloys as coatings for petrochemical devices disclosed herein provide high elastic limit/flow strength with relatively high hardness. These attributes allow these materials, when subjected to stress or strain, to stay elastic for higher strains/stresses as compared to the crystalline materials. The stress-strain relationship between the amorphous alloys as coatings for petrochemical devices and conventional crystalline alloys/steels is depicted in FIG. 3, and shows that conventional crystalline alloys/steels can easily transition into plastic deformation at relatively low strains/stresses in comparison to amorphous alloys. Premature plastic deformation at the contacting surfaces leads to surface asperity generation and the consequent high asperity contact forces and COF in crystalline metals. The high elastic limit of amorphous metallic alloys or amorphous materials in general can reduce the formation of asperities resulting also in significant enhancement of wear resistance. Amorphous alloys as coatings for petrochemical devices would result in reduced asperity formation during production operations and thereby reduced COF of the device.

Amorphous alloys as coatings for petrochemical devices may be deposited using a number of coating techniques including, but not limited to, thermal spraying, cold spraying, weld overlay, laser beam surface glazing, ion implantation and vapor deposition. Using a scanned laser or electron beam, a surface can be glazed and cooled rapidly to form an amorphous surface layer. In glazing, it may be advantageous to modify the surface composition to ensure good glass forming ability and to increase hardness and wear resistance. This may be done by alloying into the molten pool on the surface as the heat source is scanned. Hardfacing coatings may be applied also by thermal spraying including plasma spraying in air or in vacuum. Thinner, fully amorphous coatings as coatings for petrochemical devices may be obtained by thin film deposition techniques including, but not limited to, sputtering, chemical vapor deposition (CVD) and electrodeposition. Some amorphous alloy compositions disclosed herein, such as near equiatomic stoichiometry (e.g., Ni—Ti), may be amorphized by heavy plastic deformation such as shot peening or shock loading. The amorphous alloys as coatings for oil and gas well production devices disclosed herein yield an outstanding balance of wear and friction performance and require adequate glass forming ability for the production methodology to be utilized.

### Ni—P Based Composite Coatings:

Electroless and electro plating of nickel-phosphorous (Ni—P) based composites as coatings for petrochemical and chemical industry devices disclosed herein may be formed by codeposition of inert particles onto a metal matrix from an electrolytic or electroless bath. The Ni—P composite coating provides excellent adhesion to most metal and alloy substrates. The final properties of these coatings depend on the phosphorous content of the Ni—P matrix, which determines the structure of the coatings, and on the characteristics of the embedded particles such as type, shape and size. Ni—P coatings with low phosphorus content are crystalline Ni with supersaturated P. With increasing P content, the crystalline lattice of nickel becomes more and more strained and the crystallite size decreases. At a phosphorous content greater than 12 wt %, or 13 wt %, or 14 wt % or 15 wt %, the coatings exhibit a predominately amorphous structure. Annealing of amorphous Ni—P coatings may result in the transformation of amorphous structure into an to advantageous crystalline state. This crystallization may increase hardness, but deteriorate corrosion resistance. The richer the alloy in phosphorus, the slower the process of crystallization. This expands the amorphous range of the coating. The Ni—P composite coatings can incorporate other metallic elements including, but not limited to, tungsten (W) and molybdenum (Mo) to further enhance the properties of the coatings. The nickel-phosphorous (Ni—P) based composite coating disclosed herein may include micron-sized and sub-micron sized particles. Non-limiting exemplary particles include: diamonds, nanotubes, carbides, nitrides, borides, oxides and combinations thereof. Other non-limiting exemplary particles include plastics (e.g., fluoro-polymers) and hard metals.

### Layered Materials and Novel Fullerene Based Composite Coating Layers:

Layered materials such as graphite, MoS₂ and WS₂ (platelets of the 2H polytype) may be used as coatings for petrochemical and chemical industry devices. In addition, fullerene based composite coating layers which include fullerene-like nanoparticles may also be used as coatings for petrochemical and chemical industry devices. Fullerene-like nanoparticles have advantageous tribological properties in comparison to typical metals while alleviating the shortcomings of conventional layered materials (e.g., graphite, MoS₂). Nearly spherical fullerenes may also behave as nanoscale ball bearings. The main favorable benefit of the hollow fullerene-like nanoparticles may be attributed to the following three effects: (a) rolling friction, (b) the fullerene nanoparticles function as spacers, which eliminate metal to metal contact between the asperities of the two mating metal surfaces, and (c) three body material transfer. Sliding/rolling of the fullerene-like nanoparticles in the interface between rubbing surfaces may be the main friction mechanism at low loads, when the shape of nanoparticle is preserved. The beneficial effect of fullerene-like nanoparticles increases with the load. Exfoliation of external sheets of fullerene-like nanoparticles was found to occur at high contact loads (˜1 GPa). The transfer of delaminated fullerene-like nanoparticles appears to be the dominant friction mechanism at severe contact conditions. The mechanical and tribological properties of fullerene-like nanoparticles can be exploited by the incorporation of these particles in binder phases of coating layers. In addition, composite coatings incorporating fullerene-like nanoparticles in a metal binder phase (e.g., Ni—P electroless plating) can provide a film with self-lubricating and excellent anti-sticking characteristics suitable for coatings for petrochemical and chemical industry devices.

### Advanced Boride Based Cermets and Metal Matrix Composites:

Advanced boride based cermets and metal matrix composites as coatings for petrochemical and chemical industry devices may be formed on bulk materials due to high temperature exposure either by heat treatment or incipient heating during wear service. For instance, boride based cermets (e.g., TiB₂-metal), the surface layer is typically enriched with boron oxide (e.g, B₂O₃) which enhances lubrication performance leading to low friction coefficient.

### Quasicrystalline Materials:

Quasicrystalline materials may be used as coatings for petrochemical and chemical industry devices. Quasicrystalline materials have periodic atomic structure, but do not conform to the 3-D symmetry typical of ordinary crystalline materials. Due to their crystallographic structure, most commonly icosahedral or decagonal, quasicrystalline materials with tailored chemistry exhibit unique combination of properties including low energy surfaces, attractive as a coating material for petrochemical and chemical industry devices. Quasicrystalline materials provide non-stick surface properties due to their low surface energy (˜30 mJ/m²) on stainless steel substrate in icosahedral Al—Cu—Fe chemistries. Quasicrystalline materials as coating layers for petrochemical and chemical industry devices may provide a combination of low friction coefficient (˜0.05 in scratch test with diamond indentor in dry air) with relatively high microhardness (400˜600 HV) for wear resistance. Quasicrystalline materials as coating layers for petrochemical and chemical industry devices may also provide a low corrosion surface and the coated layer has smooth and flat surface with low surface energy for improved performance. Quasicrystalline materials may be deposited on a metal substrate by a wide range of coating technologies, including, but not limited to, thermal spraying, vapor deposition, laser cladding, weld overlaying, and electrodeposition.

### Super-Hard Materials (Diamond, Diamond Like Carbon, Cubic Boron Nitride):

Super-hard materials such as diamond, diamond-like-carbon (DLC) and cubic boron nitride (CBN) may be used as coatings for petrochemical and chemical industry devices. Diamond is the hardest material known to man and under certain conditions may yield ultra-low coefficient of friction when deposited by chemical vapor deposition (abbreviated herein as CVD) on petrochemical and chemical industry devices. In one form, the CVD deposited carbon may be deposited directly on the surface of the petrochemical and chemical industry device. In another form, an undercoating of a compatibilizer material (also referred to herein as a buffer layer) may be applied to the petrochemical and chemical industry device prior to diamond deposition.

In one advantageous embodiment, diamond-like-carbon (DLC) may be used as coatings for petrochemical and chemical industry devices. DLC refers to amorphous carbon material that display some of the unique properties similar to that of natural diamond. The diamond-like-carbon (DLC) suitable for petrochemical and chemical industry devices may be chosen from ta-C, ta-C:H, DLCH, PLCH, GLCH, Si-DLC, Me-DLC, F-DLC and combinations thereof. DLC coatings include significant amounts of sp³ hybridized carbon atoms. These sp³ bonds may occur not only with crystals—in other words, in solids with long-range order—but also in amorphous solids where the atoms are in a random arrangement. In this case there will be bonding only between a few individual atoms, that is short-range order, and not in a long-range order extending over a large number of atoms. The bond types have a considerable influence on the material properties of amorphous carbon films. If the sp² type is predominant the DLC film may be softer, whereas if the sp³ type is predominant, the DLC film may be harder.

DLC coatings may be fabricated as amorphous, flexible, and yet purely sp³ bonded “diamond”. The hardest is such a mixture, known as tetrahedral amorphous carbon, or ta-C (see FIG. 4). Such ta-C includes a high volume fraction (˜80%) of sp³ bonded carbon atoms. Optional fillers for the DLC coatings, include, but are not limited to, hydrogen, graphitic sp² carbon, and metals, and may be used in other forms to achieve a desired combination of properties depending on the particular application. The various forms of DLC coatings may be applied to a variety of substrates that are compatible with a vacuum environment and that are also electrically conductive. DLC coating quality is also dependent on the fractional content of alloying elements such as hydrogen. Some DLC coating methods require hydrogen or methane as a precursor gas, and hence a considerable percentage of hydrogen may remain in the finished DLC material. In order to further improve their tribological and mechanical properties, DLC films are often modified by incorporating other alloying elements. For instance, the addition of fluorine (F), and silicon (Si) to the DLC films lowers the surface energy and wettability. The reduction of surface energy in fluorinated DLC (F-DLC) is attributed to the presence of —CF2 and —CF3 groups in the film. However, higher F contents may lead to a lower hardness. The addition of Si may reduce surface energy by decreasing the dispersive component of surface energy. Si addition may also increase the hardness of the DLC films by promoting sp³ hybridization in DLC films. Addition of metallic elements (e.g., W, Ta, Cr, Ti, Mo) to the film, as well as the use of such metallic interlayer can reduce the compressive residual stresses resulting in better mechanical integrity of the film upon compressive loading.

The diamond-like phase or sp³ bonded carbon of DLC is a thermodynamically metastable phase while graphite with sp² bonding is a thermodynamically stable phase. Thus the formation of DLC coating films requires non-equilibrium processing to obtain metastable sp³ bonded carbon. Equilibrium processing methods such as evaporation of graphitic carbon, where the average energy of the evaporated species is low (close to kT where k is Boltzmann's constant and T is temperature in absolute temperature scale), lead to the formation of 100% sp² bonded carbons. The methods disclosed herein for producing DLC coatings require that the carbon in the sp³ bond length be significantly less than the length of the sp² bond. Hence, the application of pressure, impact, catalysis, or some combination of these at the atomic scale may force sp² bonded carbon atoms closer together into sp³ bonding. This may be done vigorously enough such that the atoms cannot simply spring back apart into separations characteristic of sp² bonds. Typical techniques either combine such a compression with a push of the new cluster of sp³ bonded carbon deeper into the coating so that there is no room for expansion back to separations needed for sp² bonding; or the new cluster is buried by the arrival of new carbon destined for the next cycle of impacts.

The DLC coatings disclosed herein may be deposited by physical vapor deposition, chemical vapor deposition, or plasma assisted chemical vapor deposition coating techniques. The physical vapor deposition coating methods include RF-DC plasma reactive magnetron sputtering, ion beam assisted deposition, cathodic arc deposition and pulsed laser deposition (PLD). The chemical vapor deposition coating methods include ion beam assisted CVD deposition, plasma enhanced deposition using a glow discharge from hydrocarbon gas, using a radio frequency (r.f.) glow discharge from a hydrocarbon gas, plasma immersed ion processing and microwave discharge. Plasma enhanced chemical vapor deposition (PECVD) is one advantageous method for depositing DLC coatings on large areas at high deposition rates. Plasma based CVD coating process is a non-line-of-sight technique, i.e. the plasma conformally covers the part to be coated and the entire exposed surface of the part is coated with uniform thickness. The surface finish of the part may be retained after the DLC coating application. One advantage of PECVD is that the temperature of the substrate part does not increase above about 150° C. during the coating operation. The fluorine-containing DLC (F-DLC) and silicon-containing DLC (Si-DLC) films can be synthesized using plasma deposition technique using a process gas of acetylene (C₂H₂) mixed with fluorine-containing and silicon-containing precursor gases respectively (e.g., tetra-fluoro-ethane and hexa-methyl-disiloxane).

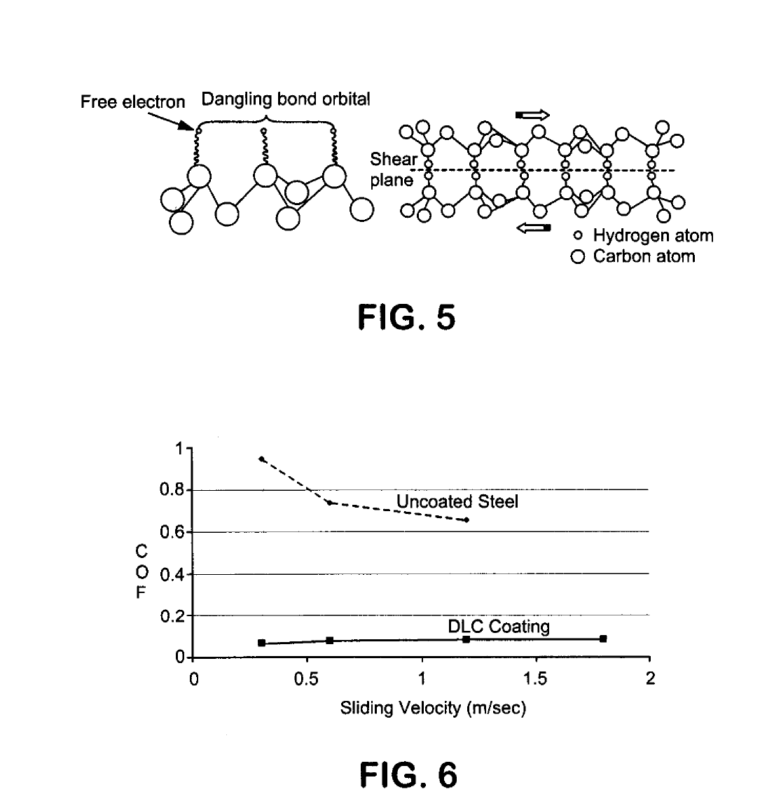

The DLC coatings disclosed herein may exhibit coefficients of friction within the ranges earlier described. The ultra-low COF may be based on the formation of a thin graphite film in the actual contact areas. As sp³ bonding is a thermodynamically unstable phase of carbon at elevated temperatures of 600 to 1500° C., depending on the environmental conditions, it may transform to graphite which may function as a solid lubricant. These high temperatures may occur as very short flash (referred to as the incipient temperature) temperatures in the asperity collisions or contacts. An alternative theory for the ultra-low COF of DLC coatings is the presence of hydrocarbon-based slippery film. The tetrahedral structure of a sp³ bonded carbon may result in a situation at the surface where there may be one vacant electron coming out from the surface, that has no carbon atom to attach to which is referred to as a “dangling bond” orbital (see FIG. 5). If one hydrogen atom with its own electron is put on such carbon atom, it may bond with the dangling bond orbital to form a two-electron covalent bond. When two such smooth surfaces with an outer layer of single hydrogen atoms slide over each other, shear will take place between the hydrogen atoms. There is no chemical bonding between the surfaces, only very weak van der Waals forces, and the surfaces exhibit the properties of a heavy hydrocarbon wax. As illustrated in FIG. 5 carbon atoms at the surface may make three strong bonds leaving one electron in the dangling bond orbital pointing out from the surface. Hydrogen atoms attach to such surface which becomes hydrophobic and exhibits low friction.

The DLC coatings for petrochemical and chemical industry devices disclosed herein also prevent wear due to their tribological properties. In particular, the DLC coatings disclosed herein are resistant to abrasive and adhesive wear making them suitable for use in applications that experience extreme contact pressure, both in rolling and sliding contact.

In addition to low friction and wear/abrasion resistance, the DLC coatings for petrochemical and chemical industry devices disclosed herein also exhibit durability and adhesive strength to the outer surface of the body assembly for deposition. DLC coating films may possess a high level of intrinsic residual stress (˜1 GPa) which has an influence on their tribological performance and adhesion strength to the substrate (e.g., steel) for deposition. Typically DLC coatings deposited directly on steel surface suffer from poor adhesion strength. This lack of adhesion strength restricts the thickness and the incompatibility between DLC and steel interface, which may result in delamination at low loads. To overcome these problems, the DLC coatings for petrochemical and chemical industry devices disclosed herein may also include interlayers of various metallic (for example, but not limited to, Cr, W, Ti) and ceramic compounds (for example, but not limited to, CrN, SiC) between the outer surface of the petrochemical and chemical industry device and the DLC coating layer. These ceramic and metallic interlayers relax the compressive residual stress of the DLC coatings disclosed herein to increase the adhesion and load carrying capabilities. An alternative approach to improving the wear/friction and mechanical durability of the DLC coatings disclosed herein is to incorporate multilayers with intermediate buffering layers to relieve residual stress build-up and/or duplex hybrid coating treatments. In one form, the outer surface of the petrochemical and chemical industry device to for treatment may be nitrided or carburized, a precursor treatment prior to DLC coating deposition, in order to harden and retard plastic deformation of the substrate layer which results in enhanced coating durability.

### Multi-Layered Coatings and Hybrid Coatings:

Multi-layered coatings on petrochemical and chemical industry devices are disclosed herein and may be used in order to maximize the thickness of the coatings for enhancing their durability. The coated petrochemical and chemical industry devices disclosed herein may include not only a single layer, but also two or more coating layers. For example, two, three, four, five or more coating layers may be deposited on portions of the petrochemical and chemical industry device. Each coating layer may range from 0.5 to 5000 microns in thickness with a lower limit of 0.5, 0.7, 1.0, 3.0, 5.0, 7.0, 10.0, 15.0, or 20.0 microns and an upper limit of 25, 50, 75, 100, 200, 500, 1000, 3000, or 5000 microns. The total thickness of the multi-layered coating may range from 0.5 to 30,000 microns. The lower limit of the total multi-layered coating thickness may be 0.5, 0.7, 1.0, 3.0, 5.0, 7.0, 10.0, 15.0, or 20.0 microns in thickness. The upper limit of the total multi-layered coating thickness may be 25, 50, 75, 100, 200, 500, 1000, 3000, 5000, 10000, 15000, 20000, or 30000 microns in thickness.

The coatings for use in petrochemical and chemical industry devices disclosed herein may also include one or more buffer layers (also referred to herein as adhesive layers). The one or more buffer layers may be interposed between the outer surface of the body assembly and the single layer or the two or more layers in a multi-layer coating configuration. The one or more buffer layers may be chosen from the following elements or alloys of the following elements: silicon, titanium, chromium, tungsten, tantalum, niobium, vanadium, zirconium, and/or hafnium. The one or more buffer layers may also be chosen from carbides, nitrides, carbo-nitrides, oxides of the following elements: silicon, titanium, chromium, tungsten, tantalum, niobium, vanadium, zirconium, and/or hafnium. The one or more buffer layers are generally interposed between the interlayer (when utilized) and one or more coating layers or between coating layers. The buffer layer thickness may be a fraction of or approach the thickness of the coating layer.

In yet another embodiment of the coated petrochemical and chemical industry devices disclosed herein, the body assembly may further include one or more buttering layers interposed between the outer surface of the body assembly and the coating layer on at least a portion of the exposed outer surface to provide enhanced toughness, to minimize any dilution from the substrate steel alloying into the outer coating, and to minimize residual stress absorption. Non-limiting exemplary buttering layers include stainless steel, an alloy steel, a cobalt based alloy, a titanium based alloy, an aluminum based alloy, a nickel based alloy, a metal matrix composite, or combinations thereof. The one or more buttering layers are generally positioned adjacent to or on top of the body assembly of the petrochemical and chemical industry device for coating.

In one advantageous embodiment of the coated petrochemical and chemical industry device disclosed herein, multilayered carbon based amorphous coating layers, such as diamond-like-carbon (DLC) coatings, may be applied to the device. The diamond-like-carbon (DLC) coatings suitable for petrochemical chemical industry device may be chosen from ta-C, ta-C:H, DLCH, PLCH, GLCH, Si-DLC, Me-DLC, N-DLC, O-DLC, B-DLC, F-DLC and combinations thereof. One particularly advantageous DLC coating for such applications is DLCH or ta-C:H. The structure of multi-layered DLC coatings may include individual DLC layers with adhesion or buffer layers between the individual DLC layers. Exemplary adhesion or buffer layers for use with DLC coatings include, but are not limited to, the following elements or alloys of the following elements: silicon, titanium, chromium, tungsten, tantalum, niobium, vanadium, zirconium, and/or hafnium. Other exemplary adhesion or buffer layers for use with DLC to coatings include, but are not limited to, carbides, nitrides, carbo-nitrides, oxides of the following elements: silicon, titanium, chromium, tungsten, tantalum, niobium, vanadium, zirconium, and/or hafnium. These buffer or adhesive layers act as toughening and residual stress relieving layers and permit the total DLC coating thickness for multi-layered embodiments to be increased while maintaining is coating integrity for durability.

### Methods for Coating for Petrochemical and Chemical Industry Device:

The current invention also relates to methods for coating petrochemical and chemical industry devices. In one exemplary embodiment, a method for coating a petrochemical and chemical industry device comprises providing a coated one or more tubular bodies, and a coating on at least a portion of the one or more tubular bodies, wherein the coating is chosen from an amorphous alloy, a heat-treated electroless or electro plated nickel-phosphorous based composite with a phosphorous content greater than 12 wt %, graphite, MoS₂, WS₂, a fullerene based composite, a boride based cermet, a quasicrystalline material, a diamond based material, diamond-like-carbon (DLC), boron nitride, and combinations thereof, and utilizing the coated petrochemical and chemical industry operations.

In one form of the method for coating petrochemical and chemical industry devices, the one or more devices may be coated with diamond-like carbon (DLC). Coatings of DLC materials may be applied by physical vapor deposition (PVD), arc deposition, chemical vapor deposition (CVD), or plasma enhanced chemical vapor deposition (PECVD) coating techniques. The physical vapor deposition coating method may be chosen from sputtering, RF-DC plasma reactive magnetron sputtering, ion beam assisted deposition, cathodic arc deposition and pulsed laser deposition. The one or more DLC coating layers may be advantageously deposited by PECVD and/or RF-DC plasma reactive magnetron sputtering methods.

### EXAMPLES

### Illustrative Example 1

In the laboratory wear/friction testing, the velocity dependence (velocity weakening or strengthening) of the friction coefficient for a DLC coating and uncoated 4142 steel was measured by monitoring the shear stress required to slide at a range of sliding velocity of 0.3 m/sec ˜1.8 m/sec. Quartz ball was used as a counterface material in the dry sliding wear test. The velocity-weakening performance of the DLC coating relative to uncoated steel is depicted in FIG. 6. Uncoated 4142 steel exhibits a decrease of friction coefficient with sliding velocity (i.e. significant velocity weakening), whereas DLC coatings show no velocity weakening and indeed, there seems to be a slight velocity strengthening of COF (i.e. slightly increasing COF with sliding velocity).

### Illustrative Example 2

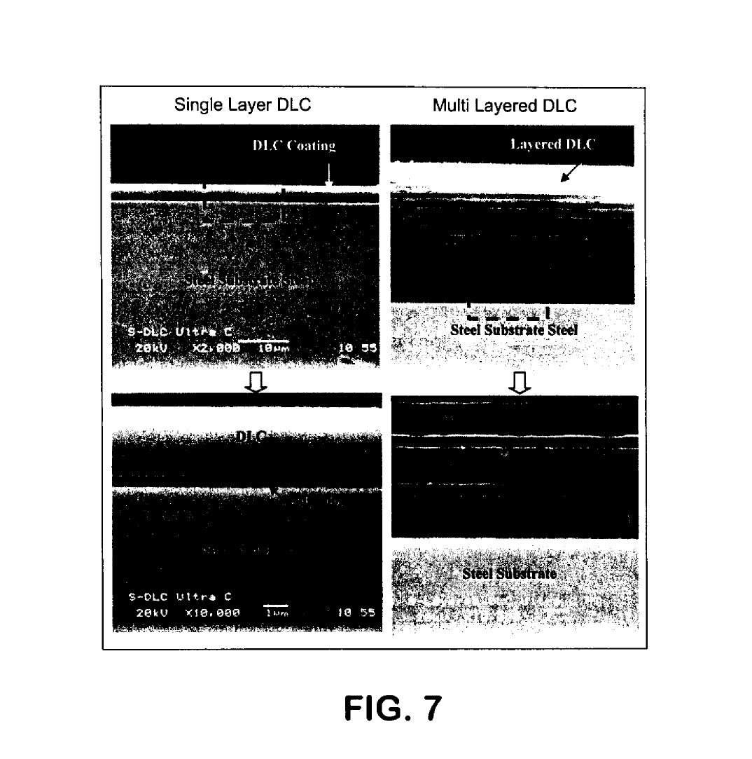

Multi-layered DLC coatings were produced in order to maximize the thickness of the DLC coatings for enhancing their durability for drill stem assemblies used in drilling operations. In one form, the total thickness of the multi-layered DLC coating varied from 6 μm to 25 μm. FIG. 7 depicts SEM images of both single layer and multilayer DLC coatings for drill stem assemblies produced via PECVD. An adhesive layer(s) used with the DLC coatings was a siliceous buffer layer.

### Illustrative Example 3

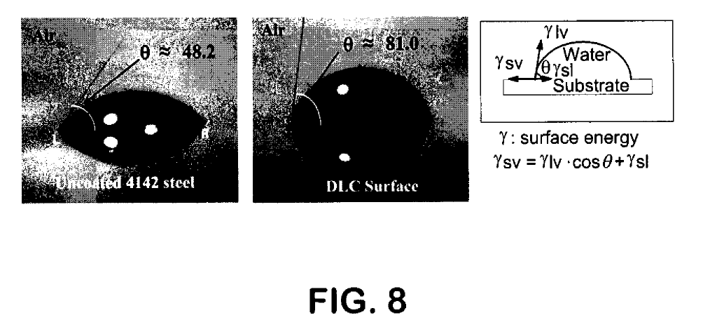

The surface energy of DLC coated substrates in comparison to an uncoated 4142 steel surface was measured via water contact angle, Results are depicted in FIG. 8 and indicate that a DLC coating provides a substantially lower surface energy in comparison to an uncoated steel surface. The lower surface energy may provide lower adherence surfaces for mitigating or reducing bit/stabilizer balling and to prevent formation of deposits of asphaltenes, paraffins, scale, and/or hydrates.

Applicants have attempted to disclose all forms and applications of the disclosed subject matter that could be reasonably foreseen. However, there may be unforeseeable, insubstantial modifications that remain as equivalents. While the present disclosure has been described in conjunction with specific, exemplary forms thereof, it is evident that many alterations, modifications, and variations will be apparent to those skilled in the art in light of the foregoing description without departing from the spirit or scope of the present disclosure. Accordingly, the present disclosure is intended to embrace all such alterations, modifications, and variations of the above detailed description.

All patents, test procedures, and other documents cited herein, including priority documents, are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

What is claimed is:

1. A coated petrochemical and chemical industry device comprising:
a petrochemical and chemical industry device including one or more tubular bodies of various shapes and size, and
a coating on at least a portion of the one or more tubular bodies,
wherein the coating is chosen from an amorphous alloy, a heat-treated electroless or electro plated based nickel-phosphorous composite with a phosphorous content greater than 12 wt. %, graphite, MoS₂, WS₂, a fullerene based composite, a boride based cermet, a quasicrystalline material, a diamond based material, diamond-like-carbon (DLC), boron nitride, and combinations thereof.

2. The coated device of claim 1, wherein the one or more tubular bodies include two or more tubular bodies in relative motion to each other.

3. The coated device of claim 1, wherein the one or more tubular bodies include two or more tubular bodies that are static relative to each other.

4. The coated device of claim 3, wherein the two or more tubular bodies include two or more radii.

5. The coated device of claim 4, wherein the two or more tubular bodies include one or more tubular bodies substantially within one or more other tubular bodies.

6. The coated device of claim 4, wherein the two or more radii are of substantially the same dimensions or substantially different dimensions.

7. The coated device of claim 4, wherein the two or more tubular bodies are contiguous to each other.

8. The coated device of claim 4, wherein the two or more tubular bodies are not contiguous to each other.

9. The coated device of claim 7 or 8, wherein the two or more tubular bodies are coaxial or non-coaxial.

10. The coated device of claim 9, wherein the bodies have substantially parallel axes.

11. The coated device of claim 1, wherein the one or more tubular bodies are helical in inner surface, helical in outer surface or a combination thereof.

12. The coated device of claim 1, wherein the one or more tubular bodies are solid, hollow or a combination thereof.

13. The coated device of claim 1, wherein the one or more tubular bodies include at least one tubular body that is substantially circular, substantially elliptical, or substantially polygonal in outer cross-section, inner cross-section or inner and outer cross-section.

14. The coated device of claim 1, wherein the coefficient of friction of the coating is less than or equal to 0.15.

15. The coated device of claim 14, wherein the coefficient of friction of the coating is less than or equal to 0.10.

16. The coated device of claim 1, wherein the coating provides a hardness of greater than 400 VHN.

17. The coated device of claim 16, wherein the coating provides a hardness of greater than 1500 VHN.

18. The coated device of claim 1, wherein the coating provides at least 3 times greater wear resistance than an uncoated device.

19. The coated device of claim 1, wherein the water contact angle of the coating is greater than 60 degrees.

20. The coated device of claim 1, wherein the coating provides a surface energy less than 1 J/m².

21. The coated device of claim 20, wherein the coating provides a surface energy less than 0.1 J/m².

22. The coated device of claim 1, wherein the coating comprises a single coating layer or two or more coating layers.

23. The coated device of claim 22, wherein the two or more coating layers are of substantially the same or different coatings.

24. The coated device of claim 22, wherein the thickness of the single coating layer and of each layer of the two or more coating layers range from 0.5 microns to 5000 microns.

25. The coated device of claim 22, wherein the coating further comprises one or more buffer layers.

26. The coated device of claim 25, wherein the one or more buffer layers are interposed between the surface of the one or more tubular bodies and the single coating layer or the two or more coating layers.

27. The coated device of claim 25, wherein the one or more buffer layers are chosen from elements, alloys, carbides, nitrides, carbo-nitrides, and oxides of the following: silicon, titanium, chromium, tungsten, tantalum, niobium, vanadium, zirconium, or hafnium.

27. The coated device of claim 1, wherein the dynamic friction coefficient of the coating is not lower than 50% of the static friction coefficient of the coating.

28. The coated device of claim 1 wherein the one or more tubular bodies further includes a buttering layer interposed between the surface of the one or more tubular bodies and the coating on at least a portion of the tubular bodies.

29. The coated device of claim 29, wherein the buttering layer comprises a stainless steel, an alloy steel, a cobalt based alloy, a titanium based alloy, an aluminum based alloy, a nickel based alloy, a metal matrix composite, or combinations thereof.

30. A coated petrochemical and chemical industry device comprising:
a petrochemical and chemical industry device chosen from extruder barrels, gears, extruder dies, bearings, compressors, pumps, pipes, tubing, molding dies, valves, and reactor vessels and combinations thereof, and
a coating on at least a portion of the device,
wherein the coating is chosen from an amorphous alloy, a heat-treated electroless or electro plated nickel-phosphorous based composite with a phosphorous content greater than 12 wt %, graphite, MoS₂, WS₂, a fullerene based composite, a boride based cermet, a quasicrystalline material, a diamond based material, diamond-like-carbon (DLC), boron nitride, and combinations thereof.

31. The coated device of claim 31, wherein the device includes two or more bodies in relative motion to each other.

32. The coated device of claim 31, wherein the device includes two or more bodies that are static relative to each other.

33. The coated device of claim 31, wherein the device includes spheres and complex geometries.

34. The coated device of claim 34, wherein the complex geometries have at least a portion that are non-tubular in shape.

35. The coated device of claim 32 or 33, wherein the two or more bodies include one or more bodies substantially within one or more other bodies.

36. The coated device of claim 31, wherein the device is solid, hollow or a combination thereof.

37. The coated device of claim 31, wherein the device includes at least one body that is substantially circular, substantially elliptical, or substantially polygonal in outer cross-section, inner cross-section or inner and outer cross-section.

38. The coated device of claim 31, wherein the coefficient of friction of the coating is less than or equal to 0.15.

39. The coated device of claim 39, wherein the coefficient of friction of the coating is less than or equal to 0.10.

40. The coated device of claim 31, wherein the coating provides a hardness of greater than 400 VHN.

41. The coated device of claim 41, wherein the coating provides a hardness of greater than 1500 VHN.

42. The coated device of claim 31, wherein the coating provides at least 3 times greater wear resistance than an uncoated device.

43. The coated device of claim 31, wherein the water contact angle of the coating is greater than 60 degrees.

44. The coated device of claim 31, wherein the coating provides a surface energy less than 1 J/m².

45. The coated device of claim 45, wherein the coating provides a surface energy less than 0.1 J/m².

46. The coated device of claim 31, wherein the coating comprises a single coating layer or two or more coating layers.

47. The coated device of claim 47, wherein the two or more coating layers are of substantially the same or different coatings.

48. The coated device of claim 48, wherein the thickness of the single coating layer and of each layer of the two or more coating layers range from 0.5 microns to 5000 microns.

49. The coated device of claim 47, wherein the coating further comprises one or more buffer layers.

50. The coated device of claim 50, wherein the one or more buffer layers are interposed between the surface of the one or more bodies and the single coating layer or the two or more coating layers.

51. The coated device of claim 51, wherein the one or more buffer layers are chosen from elements, alloys, carbides, nitrides, carbo-nitrides, and oxides of the following: silicon, titanium, chromium, tungsten, tantalum, niobium, vanadium, zirconium, or hafnium.

52. The coated device of claim 31, wherein the dynamic friction coefficient of the coating is not lower than 50% of the static friction coefficient of the coating.

53. The coated device of claim 31 wherein the device further includes a buttering layer interposed between the surface of the device and the coating on at least a portion of the device.

54. The coated device of claim 54, wherein the buttering layer comprises a stainless steel, an alloy steel, a cobalt based alloy, a titanium based alloy, an aluminum based alloy, a nickel based alloy, a metal matrix composite, or combinations thereof.

55. A method for coating a petrochemical and chemical industry device comprising:
providing a petrochemical and chemical industry device including one or more tubular bodies, and
a coating on at least a portion of the one or more tubular bodies,
wherein the coating is chosen from an amorphous alloy, a heat-treated electroless or electro plated based nickel-phosphorous composite with a phosphorous content greater than 12 wt %, graphite, MoS₂, WS₂, a fullerene based composite, a boride based cermet, a quasicrystalline material, a diamond based material, diamond-like-carbon (DLC), boron nitride, and combinations thereof, and
utilizing the coated petrochemical and chemical industry device in chemical operations.

56. The method of claim 56, wherein the one or more tubular bodies include two or more tubular bodies in relative motion to each other.

57. The method of claim 56, wherein the one or more tubular bodies include two or more tubular bodies that are static relative to each other.

58. The method of claim 56, wherein the two or more tubular bodies include two or more radii.

59. The method of claim 59, wherein the two or more tubular bodies include one or more tubular bodies substantially within one or more other tubular bodies.

60. The method of claim 60, wherein the two or more radii are of substantially the same dimensions or substantially different dimensions.

61. The method of claim 61, wherein the bodies have substantially parallel axes.

62. The method of claim 56, wherein the one or more tubular bodies are helical in inner surface, helical in outer surface or a combination thereof.

63. The method of claim 56, wherein the one or more tubular bodies are solid, hollow or a combination thereof.

64. The method of claim 56, wherein the one or more tubular bodies include at least one tubular body that is substantially circular, substantially elliptical, or substantially polygonal in outer cross-section, inner cross-section or inner and outer cross-section.

65. The method of claim 56, wherein the coefficient of friction of the coating is less than or equal to 0.15.

66. The method of claim 67, wherein the coefficient of friction of the coating is less than or equal to 0.10.

67. The method of claim 56, wherein the coating provides a hardness of greater than 400 VHN.

68. The method of claim 68, wherein the coating provides a hardness of greater than 1500 VHN.

69. The method of claim 56, wherein the coating provides at least 3 times greater wear resistance than an uncoated device.

70. The method of claim 56, wherein the water contact angle of the coating is greater than 60 degrees.

71. The method of claim 56, wherein the coating provides a surface energy less than 1 J/m².

72. The method of claim 72, wherein the coating provides a surface energy less than 0.1 J/m².

73. The method of claim 56, wherein the coating comprises a single coating layer or two or more coating layers.

74. The method of claim 74, wherein the two or more coating layers are of substantially the same or different coatings.

75. The method of claim 74, wherein the thickness of the single coating layer and of each layer of the two or more coating layers range from 0.5 microns to 5000 microns.

76. The method of claim 74, wherein the coating further comprises one or more buffer layers.

77. The method of claim 77, wherein the one or more buffer layers are interposed between the surface of the one or more tubular bodies and the single coating layer or the two or more coating layers.

78. The method of claim 77, wherein the one or more buffer layers are chosen from elements, alloys, carbides, nitrides, carbo-nitrides, and oxides of the following: silicon, titanium, chromium, tungsten, tantalum, niobium, vanadium, zirconium, or hafnium.

79. The method of claim 56, wherein the dynamic friction coefficient of the coating is not lower than 50% of the static friction coefficient of the coating.

80. The method of claim 56 wherein the one or more tubular bodies further includes a buttering layer interposed between the surface of the one or more tubular bodies and the coating on at least a portion of the tubular bodies.

81. The method of claim 81, wherein the buttering layer comprises a stainless steel an alloy steel, a cobalt based alloy, a titanium based alloy, an aluminum based alloy, a nickel based alloy, a metal matrix composite, or combinations thereof.
